(19) United States
(12) Patent Application Publication
(10) Pub. No.: US 2024/0257468 A1
(43) Pub. Date: Aug. 1, 2024

(54) APPARATUS AND METHOD FOR DETERMINING SIMILARITY BETWEEN ROTATING OBJECTS

(71) Applicant: ELECTRONICS AND TELECOMMUNICATIONS RESEARCH INSTITUTE, Daejeon (KR)

(72) Inventors: Kap Kee KIM, Daejeon (KR); Bonki KOO, Daejeon (KR)

(73) Assignee: ELECTRONICS AND TELECOMMUNICATIONS RESEARCH INSTITUTE, Daejeon (KR)

(21) Appl. No.: 18/537,544

(22) Filed: Dec. 12, 2023

(30) Foreign Application Priority Data
Jan. 30, 2023 (KR) 10-2023-0011895

(51) Int. Cl. G06T 17/30; G06T 15/20

(52) U.S. Cl. CPC G06T 17/30; G06T 15/20

(57) ABSTRACT

Disclosed is an operation method of an electronic device, the method including: identifying a first quaternion value corresponding to rotation of a first object and a second quaternion value corresponding to rotation of a second object; identifying, on the basis of the first quaternion value, a first axis around which the first object rotates; identifying, on the basis of the second quaternion value, a second axis around which the second object rotates; identifying a first rotation angle related to rotation of the first object around the first axis, and a second rotation angle related to rotation of the second object around the second axis; identifying a first angle formed by the first and second axes; identifying a second angle corresponding to a difference between the first and second rotation angles; and determining a quaternion distance between the first and second objects on the basis of the first and second angles.

### CROSS REFERENCE TO RELATED APPLICATION

The present application claims priority to Korean Patent Application No. 10-2023-0011895, filed 30 Jan. 2023, the entire contents of which is incorporated herein for all purposes by this reference.

### BACKGROUND OF THE INVENTION

### Field of the Invention

The present disclosure relates to a technology for determining similarity between rotating objects. More particularly, the present disclosure relates to a technology for analyzing similarity using quaternion values of rotating objects.

### Description of the Related Art

In general, matrixes are used to express rotation in 3D graphics. However, instead of matrixes, a quaternion, which is a mathematical concept and a complex number system composed of four values, is used. Quaternions have faster computation speed than conventional rotation matrixes and occupy less memory. In the present disclosure, quaternions, which have advantages, and the concept of quaternions are used to measure a distance between object rotations. In the related art, for a distance between two quaternions, four Euclidean distances are calculated to determine similarity. When the Euclidean distance is used, four vector values of a quaternion are set with the same weighting and the distance is measured.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure provides a method different from the Euclidean method, in which four vectors corresponding to a quaternion value are set with the same weighting and a distance is measured. The present disclosure provides a technology for measuring a distance by converting an angle difference between quaternion values into vectors and determining the degree of similarity. According to an embodiment of the present disclosure, there is provided an operation method of an electronic device, the operation method including: identifying a first quaternion value corresponding to rotation of a first object and a second quaternion value corresponding to rotation of a second object; identifying, on the basis of the first quaternion value, a first axis around which the first object rotates; identifying, on the basis of the second quaternion value, a second axis around which the second object rotates; identifying a first rotation angle related to rotation of the first object around the first axis, and a second rotation angle related to rotation of the second object around the second axis; identifying a first angle formed by the first axis and the second axis; identifying a second angle corresponding to a difference between the first rotation angle and the second rotation angle; and determining a quaternion distance between the first object and the second object on the basis of the first angle and the second angle.

In addition, the determining of the quaternion distance may include: determining vector values corresponding to the first angle and the second angle respectively; and determining the quaternion distance on the basis of the determined vector values.

In addition, the operation method may further include determining similarity between the first object and the second object on the basis of the determined quaternion distance, wherein the similarity may correspond to a value related to a degree of similarity between a rotation pose of the first object and a rotation pose of the second object.

In addition, the determining of the similarity may include: determining whether the determined quaternion distance falls within a predetermined critical range; and determining that, when the determined quaternion distance falls within the predetermined critical range, the rotation poses of the first object and the second object are similar to each other; or determining that, when the determined quaternion distance does not fall within the predetermined critical range, the rotation poses of the first object and the second object are not similar to each other.

In addition, the quaternion distance may be determined by [Equation 1].

$$\\ \begin{matrix}distance ( {q}^{{}_{} a} , {q}^{{}_{} b} ) = \sqrt{{( {θ}_{axis}^{{}_{} ab} )}^{2} + {( {θ}^{{}_{} a} - {θ}^{{}_{} b} )}^{2}} & [ Equation 1 ]\end{matrix}$$

Herein, q^{a} may denote the first quaternion value, q^{b} may denote the second quaternion value, θₐₓᵢₛ^{ab} may denote the first angle, a may denote the first rotation angle, and θ^{b} may denote the second rotation angle.

In addition, the first quaternion value and the second quaternion value may be composed of axis elements related to the respective axes around which the first object and the second object rotate, and of angle elements related to the rotation angles of the respective axes, and each of the axis elements may be composed of three vectors, and each of the angle elements may be composed of one vector.

In addition, the rotation angle of each of the respective axes of the first object and the second object may be determined on the basis of [Equation 2].

$$\\ \begin{matrix}θ = 2 {cos}^{- 1} ( {q}_{0} ) & [ Equation 2 ]\end{matrix}$$

Herein, q₀ may denote the angle element of the first quaternion value or the second quaternion value.

According to an embodiment of the present disclosure, there is provided an electronic device including: a transceiver, a storage part; and at least one control part operably connected to the transceiver or the storage part or both, wherein the at least one control part is configured to identify a first quaternion value corresponding to rotation of a first object and a second quaternion value corresponding to rotation of a second object; identify, on the basis of the first quaternion value, a first axis around which the first object rotates; identify, on the basis of the second quaternion value, a second axis around which the second object rotates; identify a first rotation angle related to rotation of the first object around the first axis, and a second rotation angle related to rotation of the second object around the second axis; identify a first angle formed by the first axis and the second axis; identify a second angle corresponding to a difference between the first rotation angle and the second rotation angle; and determine a quaternion distance between the first object and the second object on the basis of the first angle and the second angle.

In addition, the at least one control part may be further configured to, in order to determine the quaternion distance, determine vector values corresponding to the first angle and the second angle respectively, and determine the quaternion distance on the basis of the determined vector values.

In addition, the at least one control part may be further configured to determine similarity between the first object and the second object on the basis of the determined quaternion distance, wherein the similarity may correspond to a value related to a degree of similarity between a rotation pose of the first object and a rotation pose of the second object.

In addition, the at least one control part may be further configured to, in order to determine the similarity, determine whether the determined quaternion distance falls within a predetermined critical range; determine that, when the determined quaternion distance falls within the predetermined critical range, the rotation poses of the first object and the second object are similar to each other; or determine that, when the determined quaternion distance does not fall within the predetermined critical range, the rotation poses of the first object and the second object are not similar to each other.

In addition, the quaternion distance may be determined by [Equation 1].

$$\\ \begin{matrix}distance ( {q}^{{}_{} a} , {q}^{{}_{} b} ) = \sqrt{{( {θ}_{axis}^{{}_{} ab} )}^{2} + {( {θ}^{{}_{} a} - {θ}^{{}_{} b} )}^{2}} & [ Equation 1 ]\end{matrix}$$

Herein, q^{a} may denote the first quaternion value, q^{b} may denote the second quaternion value, θₐₓᵢₛ^{ab} may denote the first angle, θ^{a} may denote the first rotation angle, and θ^{b} may denote the second rotation angle.

In addition, the first quaternion value and the second quaternion value may be composed of axis elements related to the respective axes around which the first object and the second object rotate, and of angle elements related to the rotation angles of the respective axes, and each of the axis elements may be composed of three vectors, and each of the angle elements may be composed of one vector.

In addition, the rotation angle of each of the respective axes of the first object and the second object may be determined on the basis of [Equation 2].

$$\\ \begin{matrix}θ = 2 {cos}^{- 1} ( {q}_{0} ) & [ Equation 2 ]\end{matrix}$$

Herein, q⁰ may denote the angle element of the first quaternion value or the second quaternion value.

According to the method proposed in the present disclosure, a distance between rotations of objects expressed as quaternions is calculated, so that the similarity between rotation poses of the objects can be relatively accurately measured.

According to the present disclosure, a distance between two rotated objects is measured and can be used as a value for clustering, and can be used for distinguishing data to be input a classifier using deep learning. For example, the rotation degrees of the objects in two images can be compared, and the degrees of rotations can be numerically expressed. When the degrees of rotations are similar, it may be determined whether the rotations are classified as the same rotation.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart illustrating an operation of an electronic device according to an embodiment of the present disclosure;

FIG. 2 is another flowchart illustrating an operation of an electronic device according to an embodiment of the present disclosure;

FIG. 3 is a configuration diagram illustrating an electronic device according to embodiments of the present disclosure;

FIG. 4 is a diagram illustrating a method of calculating the Euclidean distance between two or more quaternions;

FIG. 5 is a diagram illustrating a relationship between an axis-angle manner and a quaternion;

FIG. 6 is a diagram illustrating a relationship between an axis-angle manner and a quaternion for each of the two quaternions.

### DETAILED DESCRIPTION OF THE INVENTION

The expression “according to some embodiments” or “according to an embodiment” used throughout the specification does not necessarily indicate the same embodiment.

Some embodiments of the present disclosure may be described into functional block components and various processing steps. Some or all of the functional blocks may be realized as any number of hardware and/or software components performing specific functions. For example, functional blocks of the present disclosure may be realized by one or more microprocessors or by circuit components for a predetermined function. In addition, for example, the functional blocks of the present disclosure may be realized in various programing or scripting languages. The functional blocks may be realized as an algorithm running on one or more processors. In addition, the present disclosure may employ conventional techniques for electronic environment setting, signal processing, and/or data processing. The terms “mechanism”, “element”, “means”, and “component” may be widely used, and are not limited to mechanical and physical components.

Furthermore, connecting lines or connecting members between constituent elements shown in the drawings are merely illustrative of functional connections and/or physical or circuit connections. Connections between constituent elements may be represented by various alternative or additional functional connections, physical connections, or circuit connections in a practical device.

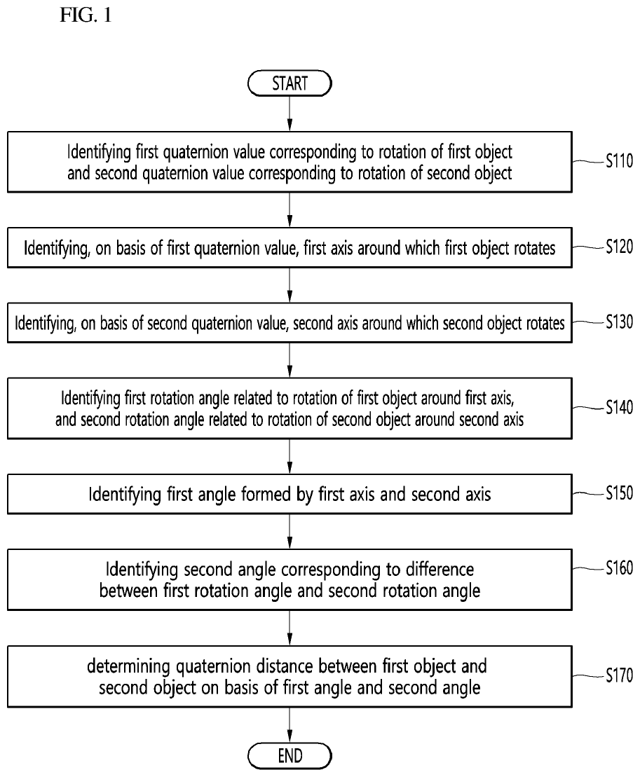

FIG. 1 is a flowchart illustrating an operation of an electronic device according to an embodiment of the present disclosure.

The operation of the electronic device shown in the flowchart of FIG. 1 may be understood as an operation of a control part that the electronic device includes. The steps to be described below are not limited to being performed in the described order unless there is a special circumstance in which the steps must be performed in that order because of a causal relationship between the listed steps.

In step S110, the electronic device identifies a first quaternion value corresponding to rotation of a first object and a second quaternion value corresponding to rotation of a second object.

A quaternion is a mathematical concept used to express rotation of any object in 3D graphics, and can be defined as a complex number system composed of four values. A quaternion is defined as a complex number value, and hereinafter, a quaternion may be referred to as a quaternion value.

Any object rotating in 3D space may be defined by a quaternion value. Accordingly, any one rotating object may have one quaternion value corresponding thereto.

In the present disclosure, at least two objects may exist in 3D space and each of the objects may rotate. Herein, the at least two objects may be referred to as a first object and a second object, respectively.

The electronic device according to an embodiment of the present disclosure may use base information on an object to identify a quaternion value corresponding to the object. More specifically, the electronic device may identify a first quaternion value corresponding to a first object and a second quaternion value corresponding to a second object. For example, the first quaternion value may be identified as (q01, q11, q21, q31), and the second quaternion value may be identified as (q02, q12, q22, q32). Herein, q01 and q02 may be elements associated with rotation angles of the respective objects, and q11, q21, and q31 may be elements associated with a rotation axis of the first object, and q12, q22, and q32 may be elements associated with a rotation axis of the second object.

The quaternion values corresponding to the objects may be identified by referring to the base information that is pre-stored in a storage part of the electronic device or obtained through an external device such as a server.

In step S120, the electronic device identifies, on the basis of the first quaternion value, a first axis around which the first object rotates.

In general, the electronic device may identify, on the basis of a quaternion value, an axis around which an object rotates. Herein, the axis may be a rotation axis related to the rotation of the object. More specifically, the first axis may be the rotation axis related to the rotation of the first object. The electronic device may identify, from the first quaternion value, an axis element related to the rotation axis of the first object. Afterward, the electronic device may identify, on the basis of the axis element, the first axis corresponding to the first object. For example, the electronic device may identify q11, q21, and q31 corresponding to the axis element from the quaternion value (q01, q11, q21, q31) of the first object, and may identify the first axis on the basis of the identified q11, q21, and q31.

In step S130, the electronic device identifies, on the basis of the second quaternion value, a second axis around which the second object rotates.

The electronic device may identify, from the second quaternion value, an axis element relates to the rotation axis of the second object. Afterward, the electronic device may identify, on the basis of the axis element, the second axis corresponding to the second object. For example, the electronic device may identify q12, q22, and q32 corresponding to the axis element from the quaternion value (q02, q12, q22, q32) of the second object, and may identify the second axis on the basis of the identified q12, q22, and q32.

In step S140, the electronic device identifies a first rotation angle related to the rotation of the first object around the first axis and a second rotation angle related to the rotation of the second object around the second axis.

In general, the electronic device may identify a rotation angle through which an object rotates around a rotation axis. Herein, the rotation angle may be a value corresponding to how much the object rotates around the rotation axis. More specifically, the electronic device may identify the degrees to which the first object and the second object rotate around the respective rotation axes, and may identify respective rotation angles, the first rotation angle and the second rotation angle.

Herein, the respective rotation angles may be determined on the basis of the quaternion values corresponding to the respective objects. For example, the first rotation angle may be determined on the basis of q01 corresponding to the rotation element in the first quaternion value.

In step S150, the electronic device identifies a first angle formed by the first axis and the second axis.

The electronic device may identify an angle formed by the rotation axes corresponding to the respective objects. More specifically, the electronic device may identify an angle or a value corresponding to the angle formed by the first axis and the second axis identified in steps S120 and S130.

In step S160, the electronic device identifies a second angle that corresponds to a difference between the first rotation angle and the second rotation angle.

The electronic device may identify an angle corresponding to a difference between the rotation angles corresponding to the respective objects. More specifically, the electronic device may identify a difference angle or a value corresponding to the difference angle between the first rotation angle and the second rotation angle identified in step S140.

In step S170, the electronic device determines, on the basis of the first angle and the second angle, a quaternion distance between the first object and the second object.

The electronic device according to an embodiment of the present disclosure may determine the quaternion distance through the first angle and the second angle identified in the above-described steps. Specifically, the electronic device may determine the quaternion distance on the basis of Equation 1 below.

$$\\ \begin{matrix}distance ( {q}^{{}_{} a} , {q}^{{}_{} b} ) = \sqrt{{( {θ}_{axis}^{{}_{} ab} )}^{2} + {( {θ}^{{}_{} a} - {θ}^{{}_{} b} )}^{2}} & [ Equation 1 ]\end{matrix}$$

Herein, q^{a} denotes the first quaternion value, q^{b} denotes the second quaternion value, distance (q^{a}, q^{b}) denotes the quaternion distance between the first object and the second object, θₐₓᵢₛ^{ab} denotes the first angle, θ^{a} denotes the first rotation angle, and θ^{b} denotes the second rotation angle.

Through this calculation process, the electronic device according to an embodiment of the present disclosure is capable of expressing the concept of a quaternion, represented by an axis (q1, q2, q3) and a rotation angle (q0) of the axis that represent the rotation of an object, as two angle values rather than four values.

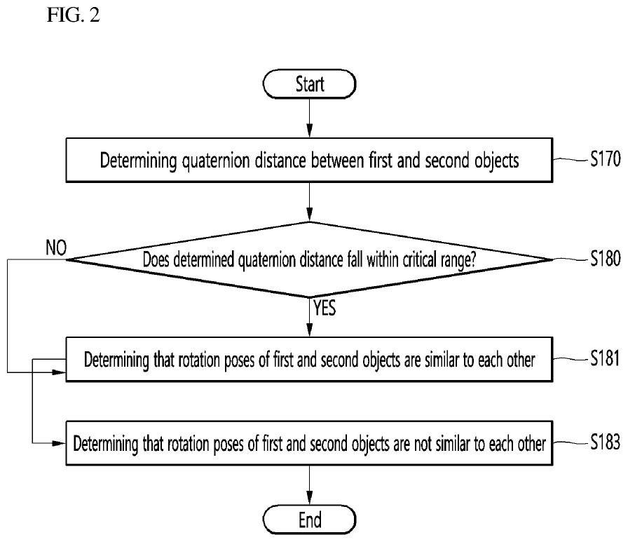

FIG. 2 is another flowchart illustrating an operation of an electronic device according to an embodiment of the present disclosure.

In step S170, the electronic device may determine a quaternion distance between a first object and a second object.

The above step may include the operation the same as or similar to step S170 of FIG. 1.

In step S180, the electronic device may determine whether the determined quaternion distance falls within a predetermined critical range.

Herein, the critical range may be a predetermined reference range for determining the similarity in rotation of two objects. Accordingly, the electronic device may determine whether rotation poses of the first object and the second object are similar, depending on whether the quaternion distance falls within the predetermined reference range or not.

In step S181, the electronic device determines that the rotation poses of the first object and the second object are similar to each other.

In response to the determined quaternion distance identified as falling within the critical range, the electronic device may determine that the rotation poses of the two objects are similar. Herein, a rotation pose may be a numerical value corresponding to physical quantity or geometric information or both associated with the rotation of each object. For example, when the first object and the second object have similar rotation poses, the two objects may be clustered into one group. Herein, one group resulting from clustering may be used as data to be input to a classifier using deep learning.

In step S183, the electronic device determines that the rotation poses of the first object and the second object are not similar to each other.

In response to the determined quaternion distance identified as not falling within the critical range, the electronic device may determine that the rotation poses of the two objects are not similar.

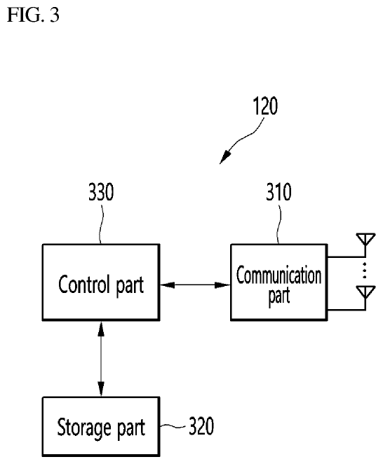

FIG. 3 is a configuration diagram illustrating an electronic device according to various embodiments of the present disclosure. The configuration illustrated in FIG. 3 may be understood as a configuration of an electronic device 120. The terms “˜ part”, “˜ unit”, and the like used below mean a unit for processing at least one function or operation, and may be implemented by hardware, software, or a combination of hardware and software.

Referring to FIG. 3, the electronic device may include a communication part 310, a storage part 320, and a control part 330.

The communication part 310 may perform function for transmitting and receiving signals through a wireless channel. For example, the communication part 310 may perform a function of conversion between a baseband signal and a bit string according to the physical layer standards of a system. For example, when transmitting data, the communication part 310 may generate complex symbols by encoding and modulating a transmission bit string. When receiving data, the communication part 310 may restore a reception bit string by demodulating and decoding a baseband signal. In addition, the communication part 310 may up-convert a baseband signal into an RF band signal and transmit the RF band signal through an antenna, and may down-convert an RF band signal received through an antenna into a baseband signal. For example, the communication part 310 may include a transmission filter, a reception filter, an amplifier, a mixer, an oscillator, a DAC, and an ADC.

In addition, the communication part 310 may include multiple transmission and reception paths. Furthermore, the communication part 310 may include at least one antenna array composed of multiple antenna elements. In terms of hardware, the communication part 310 may be a digital circuit and an analog circuit (for example, a radio frequency integrated circuit (RFIC)). Herein, the digital circuit and the analog circuit may be realized as one package. In addition, the communication part 310 may include multiple RF chains. Furthermore, the communication part 310 may perform beamforming.

The communication part 310 transmits and receives signals as described above. Accordingly, all or part of the communication part 310 may be referred to as a “transmitter”, “receiver”, or “transceiver”. In addition, in the following description, transmittion and reception performed through a wireless channel may be used to mean that the communication part 310 performs the above-described processing.

The storage part 320 may store therein data, such as default programs, application programs, and setting information for the operation of the electronic device. The storage part 320 may be a volatile memory, a non-volatile memory, or a combination of a volatile memory and a non-volatile memory. In addition, the storage part 320 may provide stored data according to a request of the control part 330.

The control part 330 may controll overall operations of the electronic device. For example, the control part 330 may transmit and receive signals through the communication part 310. In addition, the control part 330 may record data on the storage part 320 and may read the data. The control part 330 may perform functions of a protocol stack that communication standards require. To this end, the control part 330 may include at least one processor or microprocessor, or may be part of a processor. In addition, part of the communication part 310 and the control part 330 may be referred to as a communication processor (CP).

According to various embodiments, the control part 330 may identify a quaternion value corresponding to an object, may identify a rotation axis around which an object rotates and/or a rotation angle through which an object rotates, and may determine a quaternion distance on the basis of respective rotation axes and rotation angles corresponding to at least two objects. The transceiver 310 of the electronic device may obtain base information from an external server. The control part 330 may use the base information to identify at least one selected from the group of a quaternion value, a rotation axis, a rotation angle, and a quaternion distance corresponding to an object. In addition, the control part 330 may perform control such that the electronic device performs operations according to various embodiments that will be described later.

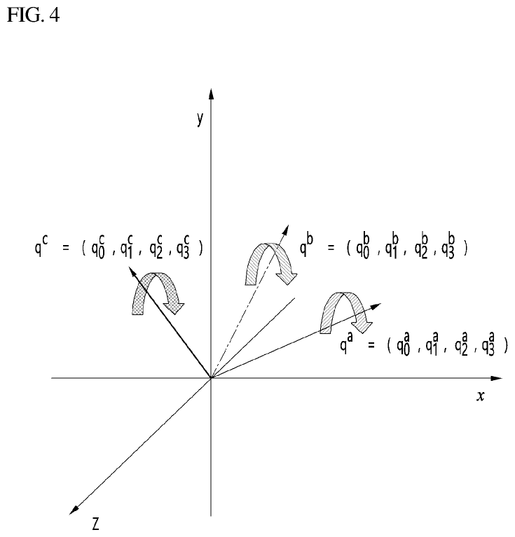

FIG. 4 is a diagram illustrating a method of calculating the Euclidean distance between two or more quaternions.

Referring to FIG. 4, a distance between quaternion a and quaternion b respectively corresponding to object a and object b may be calculated as the Euclidean distance.

According to the present disclosure, the concept of a quaternion, represented by an axis (q1, q2, q3) and a rotation angle (q0) of the axis that represent the rotation of object a or object b, is expressed as two angle values rather than four values, so that the similarity between rotation poses of two different objects can be identified more efficiently.

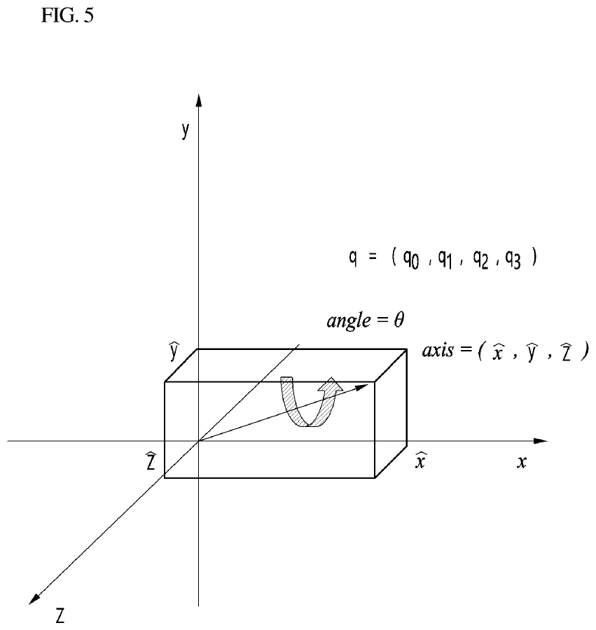

FIG. 5 is a diagram illustrating a relationship between an axis-angle manner and a quaternion.

The present disclosure proposes a method different from the Euclidean method, in which four vectors corresponding to a quaternion value are set with the same weighting and a distance is measured. According to the present disclosure, an angle difference between two rotations, that is, quaternions, is converted into a vector and a distance is measured and the degree of similarity is determined.

Referring to FIG. 5, the relationship between the axis-angle manner and a quaternion may be expressed graphically. One quaternion may be expressed as an axis-angle value.

Equation 2 and Equation 3 below show a relationship of conversion from a quaternion to an axis-angle manner in mathematical form.

$$\\ \begin{matrix}θ = 2 {cos}^{- 1} ( {q}_{0} ) & [ Equation 2 ]\end{matrix}$$

Herein, θ denotes a rotation angle of an object, and q₀ denotes a rotation element in the quaternion value of the object.

$$\\ \begin{matrix}( \hat{x} , \hat{y} , \hat{z} ) = ( \frac{{q}_{1}}{sin \frac{θ}{2}} , \frac{{q}_{2}}{sin \frac{θ}{2}} , \frac{{q}_{3}}{sin \frac{θ}{2}} ) & [ Equation 3 ]\end{matrix}$$

(\hat{x}, ŷ, \hat{z}) denotes a rotation axis of an object, and q₁, q₂, q₃ denotes an axis element in the quaternion value of the object.

According to Equation 2 and Equation 3, the electronic device may calculate an angle using a quaternion value, and may calculate an axis value using the angle together with the remaining quaternion value. The present disclosure relates to a method of measuring a distance distance between quaternions, and an axis and a rotation angle constituting a quaternion may be used as a unit of distance measurement.

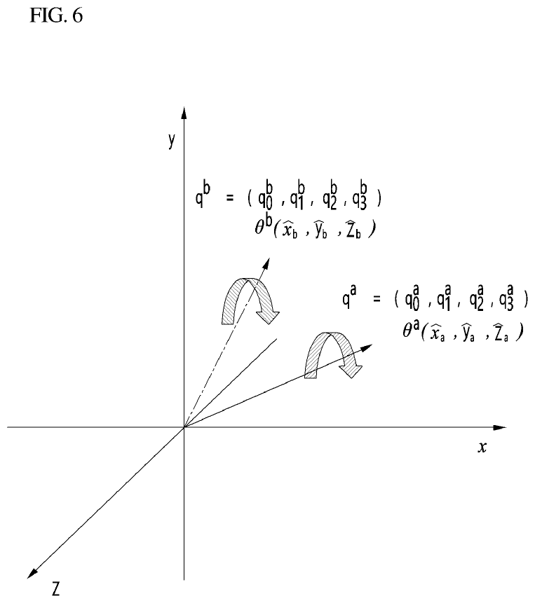

FIG. 6 is a diagram illustrating a relationship between an axis-angle manner and a quaternion for each of the two quaternions.

A method for the electronic device according to an embodiment of the present disclosure to measure a distance between two quaternion values may be performed through Equation 4 and Equation 5 below. The distance between two quaternions may be expressed as the distance in Equation 4. More specifically, the distance may be expressed as a square root of the sum of the square of an angle formed by two axes and the square of a difference between rotation angles of the axes.

$$\\ \begin{matrix}distance ( {q}^{{}_{} a} , {q}^{{}_{} b} ) = \sqrt{{( {θ}_{axis}^{{}_{} ab} )}^{2} + {( {θ}^{{}_{} a} - {θ}^{{}_{} b} )}^{2}} & [ Equation 4 ]\end{matrix}$$

Herein θₐₓᵢₛ^{ab} denotes the angle formed by the respective rotation axes of object a and object b, θ^{a}-θ^{b} and denotes the difference between the respective rotation angles of object a and object b.

$$\\ \begin{matrix}{θ}_{axis}^{{}_{} ab} = {cos}^{- 1} ( \frac{a \cdot b}{\vert a \vert \cdot \vert b \vert} ) & [ Equation 5 ]\end{matrix}$$

$$\\ a = ( , , ) , b = ( , , )$$

$$\\ \vert a \vert = \sqrt{{{}_{} 2}^{} + {{}_{} 2}^{} + {{}_{} 2}^{}} , a \cdot b = + +$$

The quaternion distance in Equation 4 may be derived by referring to the detailed equations in Equation 5.

The embodiments of the present disclosure described above are not realized only through an apparatus and a method, and may be implemented through a program that executes functions corresponding to the configurations of the embodiments of the present disclosure or through a recording medium on which the program is recorded.

Although preferred embodiments of the present disclosure have been described for illustrative purposes, those skilled in the art will appreciate that various modifications, additions and substitutions are possible, without departing from the scope and spirit of the disclosure as disclosed in the accompanying claims.

Specific embodiments for implementing the present disclosure have been described. The present disclosure may include the above-described embodiments as well as embodiments simply changed in design or easily changed. In addition, the present disclosure may also include techniques easily modified using the embodiments and implemented. Therefore, the scope of the present disclosure should not be defined as being limited to the embodiments, but should be defined by the appended claims and equivalents thereof.

What is claimed is:

1. An operation method of an electronic device, the operation method comprising:
identifying a first quaternion value corresponding to rotation of a first object and a second quaternion value corresponding to rotation of a second object;
identifying, on the basis of the first quaternion value, a first axis around which the first object rotates;
identifying, on the basis of the second quaternion value, a second axis around which the second object rotates;
identifying a first rotation angle related to rotation of the first object around the first axis,
and a second rotation angle related to rotation of the second object around the second axis;
identifying a first angle formed by the first axis and the second axis;
identifying a second angle corresponding to a difference between the first rotation angle and the second rotation angle; and
determining a quaternion distance between the first object and the second object on the basis of the first angle and the second angle.

2. The operation method of claim 1, wherein the determining of the quaternion distance comprises:
determining vector values corresponding to the first angle and the second angle respectively; and
determining the quaternion distance on the basis of the determined vector values.

3. The operation method of claim 1, further comprising determining similarity between the first object and the second object on the basis of the determined quaternion distance,
wherein the similarity corresponds to a value related to a degree of similarity between a rotation pose of the first object and a rotation pose of the second object.

4. The operation method of claim 3, wherein the determining of the similarity comprises:
determining whether the determined quaternion distance falls within a predetermined critical range; and
determining that, when the determined quaternion distance falls within the predetermined critical range, the rotation poses of the first object and the second object are similar to each other, or
determining that, when the determined quaternion distance does not fall within the predetermined critical range, the rotation poses of the first object and the second object are not similar to each other.

5. The operation method of claim 1, wherein the quaternion distance is determined by [Equation 1] [symbol]
[Equation 1]
herein, [symbol] denotes the first quaternion value, [symbol] denotes the second quaternion value, [symbol] denotes the first angle, [symbol] denotes the first rotation angle, and [symbol] denotes the second rotation angle.

6. The operation method of claim 1, wherein the first quaternion value and the second quaternion value are composed of axis elements related to the respective axes around which the first object and the second object rotate, and of angle elements related to the rotation angles of the respective axes, and
each of the axis elements is composed of three vectors, and each of the angle elements is composed of one vector.

7. The operation method of claim 6, wherein the rotation angle of each of the respective axes of the first object and the second object is determined on the basis of [Equation 2] [symbol]
[Equation 2]
herein, [symbol] denotes the angle element of the first quaternion value or the second quaternion value.

8. An electronic device, comprising:
a transceiver;
a storage part; and
at least one control part operably connected to the transceiver or the storage part or both,
wherein the at least one control part is configured to
identify a first quaternion value corresponding to rotation of a first object and a second quaternion value corresponding to rotation of a second object,
identify, on the basis of the first quaternion value, a first axis around which the first object rotates,
identify, on the basis of the second quaternion value, a second axis around which the second object rotates,
identify a first rotation angle related to rotation of the first object around the first axis, and a second rotation angle related to rotation of the second object around the second axis,
identify a first angle formed by the first axis and the second axis,
identify a second angle corresponding to a difference between the first rotation angle and the second rotation angle, and
determine a quaternion distance between the first object and the second object on the basis of the first angle and the second angle.

9. The electronic device of claim 8, wherein the at least one control part is further configured to, in order to determine the quaternion distance,
determine vector values corresponding to the first angle and the second angle respectively, and
determine the quaternion distance on the basis of the determined vector values.

10. The electronic device of claim 8, wherein the at least one control part is further configured to determine similarity between the first object and the second object on the basis of the determined quaternion distance,
wherein the similarity corresponds to a value related to a degree of similarity between a rotation pose of the first object and a rotation pose of the second object.

11. The electronic device of claim 10, wherein the at least one control part is further configured to, in order to determine the similarity,
determine whether the determined quaternion distance falls within a predetermined critical range, and
determine that, when the determined quaternion distance falls within the predetermined critical range, the rotation poses of the first object and the second object are similar to each other, or
determine that, when the determined quaternion distance does not fall within the predetermined critical range, the rotation poses of the first object and the second object are not similar to each other.

12. The electronic device of claim 8, wherein the quaternion distance is determined by [Equation 1] [symbol]
[Equation 1]
herein, [symbol] denotes the first quaternion value, [symbol] denotes the second quaternion value, [symbol] denotes the first angle, [symbol] denotes the first rotation angle, and [symbol] denotes the second rotation angle.

13. The electronic device of claim 8, wherein the first quaternion value and the second quaternion value are composed of axis elements related to the respective axes around which the first object and the second object rotate, and of angle elements related to the rotation angles of the respective axes, and
each of the axis elements is composed of three vectors, and each of the angle elements is composed of one vector.

14. The electronic device of claim 13, wherein the rotation angle of each of the respective axes of the first object and the second object is determined on the basis of [Equation 2] [symbol]
[Equation 2]
herein, [symbol] denotes the angle element of the first quaternion value or the second quaternion value.
